(19) United States
(12) Patent Application Publication
(10) Pub. No.: US 2026/0089389 A1
(43) Pub. Date: Mar. 26, 2026

(54) METHOD AND APPARATUS FOR CONTROLLING IMAGING SYSTEM HAVING MULTIPLE CAMERA MODULES AND RELATED COMPUTER READABLE MEDIUM

(71) Applicant: MEDIATEK INC., Hsinchu City (TW)

(72) Inventors: Chih-Hsiang Yu, Hsinchu City (TW); Jin-Li Ye, Hsinchu City (TW); Tzu-Han Wu, Hsinchu City (TW); Yi Lee, Hsinchu City (TW); Chi-Wei Hsu, Hsinchu City (TW); Ping-Hsien Lee, Hsinchu City (TW)

(73) Assignee: MEDIATEK INC., Hsinchu City (TW)

(21) Appl. No.: 18/896,913

(22) Filed: Sep. 26, 2024

(51) Int. Cl. H04N 23/66; G06V 10/25; G06V 10/75; H04N 23/88; H04N 23/90

(52) U.S. Cl. CPC H04N 23/66; G06V 10/25; G06V 10/758; H04N 23/88; H04N 23/90

(57) ABSTRACT

A method of controlling an imaging system having a plurality of camera modules includes: operating a first camera module of the plurality of camera modules to generate at least one first frame; operating a second camera module of the plurality of camera modules to generate at least one second frame; generating first statistics based on the at least one first frame and generating second statistics based on the at least one second frame; and determining a first tuning target of imaging control parameters of the first camera module based on at least the first statistics.

### BACKGROUND

The present invention relates to imaging systems, and more particularly, to a method and an apparatus for controlling an imaging system having multiple camera modules and related computer readable medium.

Spatial Alignment Transformation (SAT) zoom, widely adopted in multi-camera systems, enables seamless transitions between different focal lengths. However, maintaining 3A (auto-exposure, auto-white balance, auto-focus) consistency across camera modules presents significant challenges due to inherent differences in sensor characteristics. Conventional approaches, where a viewing camera module is utilized in determining 3A tuning targets, often result in inconsistent color and brightness presentation during camera module switching. To address this issue, a background master decision mechanism is proposed, which activates at least two camera modules simultaneously: one as a foreground viewing camera module for live preview and capture, and another well-tuned camera module (i.e., tuned for 3A consistency decision-making) as a background master camera module for determining 3A tuning targets across all camera modules. Such an approach reduces tuning efforts and potentially improves consistency while introduces challenges such as increased power consumption and potential latency in 3A consistency.

### SUMMARY

With this in mind, it is one object of the present invention to provide a 3A consistency decision-making and control mechanism for controlling an imaging system having a plurality of camera modules. In embodiments of the present invention, multiple camera modules of the imaging system can be activated concurrently, where at least one of the activated camera modules is operated in a low power state (e.g., a low frame per second (FPS) mode, a low resolution mode, and/or a non-high dynamic range (non-HDR) or standard dynamic range (SDR) capturing mode), while at least one of the activated camera modules is operated in a normal power state. In the 3A consistency decision-making and control mechanism of the present invention, statistics generated based on frames of more than one activated camera modules are taken into consideration to determine 3A tuning target of imaging control parameters of camera modules.

According to one embodiment, a method of controlling an imaging system having a plurality of camera modules is provided. The method comprises: operating a first camera module of the plurality of camera modules to generate at least one first frame; operating a second camera module of the plurality of camera modules to generate at least one second frame; generating first statistics based on the at least one first frame and generating second statistics based on the at least one second frame; and determining a first tuning target of imaging control parameters of the first camera module based on at least the first statistics.

According to one embodiment, a computer readable medium is provided. The computer readable medium comprises a plurality of instructions. In response to the plurality of instructions being executed on a computing device, the computing device is caused the computing device to perform operations including: operating a first camera module of the plurality of camera modules to generate at least one first frame; operating a second camera module of the plurality of camera modules to generate at least one second frame; generating first statistics based on the at least one first frame and generating second statistics based on the at least one second frame; and determining a first tuning target of imaging control parameters of the first camera module based on at least the first statistics.

According to one embodiment, an apparatus for controlling an imaging system is provided. The apparatus comprises: at least one memory and at least one processor. The at least one memory is configured to store a plurality of instructions. The at least one processor is communicatively coupled to the least one memory, and configured to execute the plurality of instructions to perform operations of: generating first statistics based on at least one first frame that is derived by operating a first camera module of a plurality of camera modules of the imaging system; generating second statistics based on at least one second frame that is derived by operating a second camera module of the plurality of camera modules; and determining a first tuning target of imaging control parameters of the first camera module based on at least the first statistics.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an imaging system and a corresponding electronic device according to one embodiment of the present invention.

FIG. 2 illustrates a flow chart of a method of controlling an imaging system having a plurality of camera modules according to one embodiment of the present invention.

FIG. 3 illustrates how to determine tuning targets for different camera modules according to one embodiment of the present invention.

FIG. 4 illustrates how to perform FOV alignment according to one embodiment of the present invention.

FIG. 5 illustrates a flow chart of a method of determining the first statistics and the second statistics according to a first embodiment of the present invention.

FIG. 6 illustrates a flow chart of a method of determining the first statistics and the second statistics according to a second embodiment of the present invention.

### DETAILED DESCRIPTION

In the following description, numerous specific details are set forth to provide a thorough understanding of the present embodiments. It will be apparent, however, to one having ordinary skill in the art that the specific detail need not be employed to practice the present embodiments. In other instances, well-known materials or methods have not been described in detail to avoid obscuring the present embodiments.

Reference throughout this specification to “one embodiment”, “an embodiment” or “some embodiments” means that a particular feature, structure or characteristic described in connection with the embodiment or example is included in at least one embodiment of the present embodiments. Thus, appearances of the phrases “in one embodiment”, “in an embodiment” or “in some embodiments” in various places throughout this specification are not necessarily all referring to the same embodiment(s). Furthermore, the particular features, structures or characteristics may be combined in any suitable combinations and/or sub-combinations in one or more embodiments.

### Overview

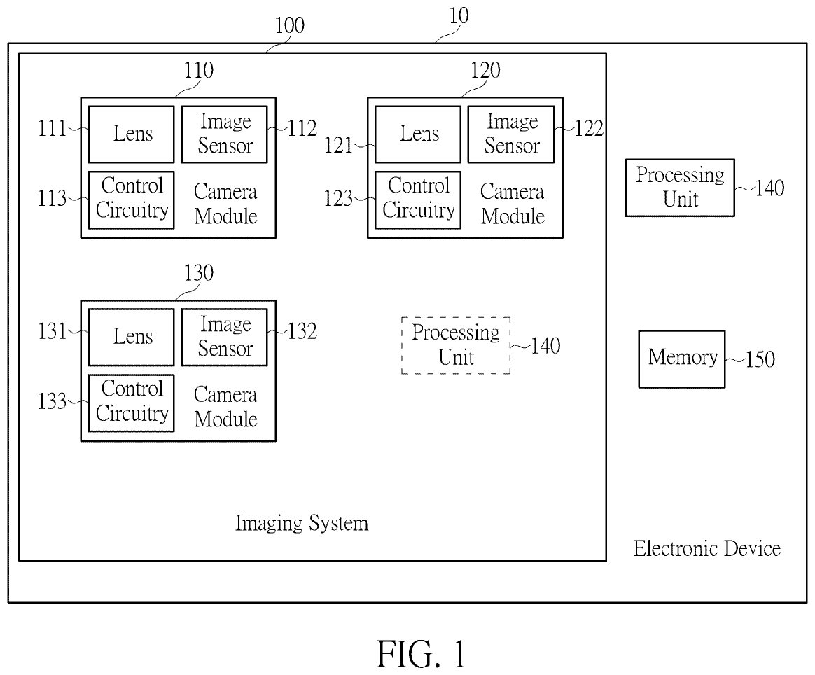

FIG. 1 illustrates an imaging system and a corresponding electronic device according to one embodiment of the present invention. The imaging system of the present invention may be applied to and disposed in mobile phones, tablet computers, laptop computers, digital cameras, camcorders, and augmented or virtual reality headsets, home security cameras, facial recognition access control systems, vehicle dash cams, satellite imaging systems, drone cameras, 360-degree surround view systems, cinematography cameras, broadcast-grade video cameras, and virtual studio systems or other types of electronic devices for photo or video shooting purposes. As illustrated by FIG. 1, the imaging system 100 may be disposed in an electronic device 10 and may comprise a plurality of camera modules 110, 120, and 130. In some embodiments, each of the camera modules 110, 120, and 130 may comprise a lens (i.e., 111, 121, and 131), an image sensor (i.e., 112, 122, and 132), and control circuitry (i.e., 113, 123, and 133). Please note that the number of camera modules described in this embodiment is provided for illustrative purposes and should not be construed as a limitation of the present invention. According to various embodiments of the present invention, the imaging system 100 may comprise fewer than three or more than three camera modules.

In some embodiments, the lenses 111, 121, and 131 may be configured with different optical characteristics, such as focal length, aperture size, and field of view, to provide diverse imaging capabilities. In some embodiments, the image sensors 112, 122, and 132 may be solid-state electronic devices, such as complementary metal-oxide-semiconductor (CMOS) or charge-coupled device (CCD) sensors, capable of converting optical images into electronic signals. The image sensors 112, 122, and 132 may vary in resolution, pixel size, and sensitivity to accommodate different imaging requirements. The control circuitry 113, 123, and 133 may comprise microprocessors, digital signal processors (DSPs), or application-specific integrated circuits (ASICs) operable to manage the operation of each of camera modules 110, 120, and 130. The control circuitry 113, 123, and 133 may control functions such as auto-focus, auto-white-balance, and/or auto-exposure adjustment, image stabilization, and data processing.

Specifically, each of the camera modules 110, 120, and 130 may respectively correspond to a specific focal length and be operable to perform photo or video shooting at the specific focal length. For instance, the camera module 110 might be configured for ultra-wide-angle shots with a shorter focal length (e.g., 16 mm equivalent), the camera module 120 for wide-angle shots with a medium focal length (e.g., 28 mm equivalent), and the camera module 130 for telephoto shots with a longer focal length (e.g., 85 mm equivalent). In some embodiments, each of the camera modules 110, 120, and 130 is equipped with high dynamic range (HDR) imaging capabilities. Each of the camera modules 110, 120, and 130 is designed with the flexibility to operate in either HDR or standard dynamic range (SDR) capturing mode, based on scene conditions and specific imaging requirements.

In some embodiments, at least two of the camera modules 110, 120 and 130 are activated concurrently for the purpose of 3A consistency decision-making and control. Each of the activated camera modules is operated in either a foreground state or a background state. That is, each of the camera modules 110, 120 and 130 is configurable to operate in the foreground state or the background state if it is activated. When a camera module is operated in the foreground state, namely as a “foreground viewing” camera module, at least one frame generated by the foreground viewing camera module is used for live preview and image/video capture, as well as 3A consistency decision-making and control. In addition, when a camera module is operated in the background state, namely as a “background master” camera module, at least one frame generated by the background master camera module is used for 3A consistency decision-making and control.

Due to power consumption concern, a power control policy may be executed to reduce power consumption of activated camera modules. In some embodiments, the background master camera module may be operated in a low power state, while the foreground viewing camera module may be operated in normal power state. In some embodiments, the background master camera module may be operated in a low frame rate mode (e.g., 20, 10 or 5 frame per second (FPS)) to achieve lower power consumption, while the foreground viewing camera module may be operated in a normal frame rate mode (e.g., 30 FPS). In some embodiments, the background master camera module may be operated in a low resolution mode to achieve lower power consumption, while the foreground viewing camera module may be operated in a high or native resolution mode. Specifically, the background master camera module is capable of outputting frames with reduced resolution compared to the native image sensor output resolution, utilizing techniques such as pixel binning or skip sampling. In some embodiments, the background master camera module may be operated in the non-HDR or SDR capturing mode, achieving low power consumption, while the foreground viewing camera module may be operated in the HDR capturing mode.

In some embodiments, a processing unit 140 may communicatively be coupled to the camera modules 110, 120 and 130. The processing unit 140 may be configured to execute instructions and/or reference data or information stored in a memory 150 for tasks such as image fusion, noise reduction, color correction, lens distortion correction, image stabilization, and/or HDR processing. In some embodiment, the processing unit 140 may be operable to achieve depth mapping for portrait mode effects, super-resolution imaging through multi-frame synthesis, and enhanced low-light performance through image stacking. Furthermore, the processing unit 140 may be configured to coordinate the operation of the camera modules 110, 120 and 130, enabling seamless switching between different focal lengths and ensuring optimal image quality across various shooting scenarios.

According to various embodiments of the present invention, the processing unit 140 may be implemented in multiple configurations to optimize performance, power efficiency, and integration within the imaging system 100 or the electronic device 10. In some embodiments, the processing unit 140 may be integrated into the imaging system 100 or disposed in the electronic device 10. For example, the processing unit 140 may be a specific imaging processing circuitry embedded in a System-on-Chip (SoC) of the electronic device 10, such as a part of an image signal processor (ISP) in a mobile phone SoC. Alternatively, the processing unit 140 may be implemented as a standalone image signal processor. The processing unit 140 may also employ a distributed architecture, with certain low-level processing tasks performed by circuitry proximal to the image sensors, while more complex computations are handled by a central processor. In some embodiments, to handle parallel processing of multiple image streams, the processing unit 140 may has a multi-core architecture, allowing simultaneous processing of data from the image sensors 112, 122, and 132.

In view of above, the imaging system 100 can serve as a variable focal length imaging system, capable of capturing high-quality images and videos across a wide range of focal lengths without the need for mechanical zoom mechanisms. The imaging system 100 not only enhances the versatility of the imaging capabilities but also contributes to the compact form factor of the electronic device 10.

### 3A Consistency Decision-Making and Control

Due to the inherent characteristics of different image sensors and lenses, images outputted by the camera modules 110, 120, and 130 may exhibit varying tendencies in brightness and color presentation. This discrepancy can lead to noticeable and unnatural changes in the live preview when a user switches between camera modules 110, 120 and 130 (i.e., to alter the shooting focal length). Such inconsistencies may detract from the user experience and the overall quality of the imaging system. To address this issue, the present invention proposes a method for controlling an imaging system having a plurality of multiple camera modules. The method of the present invention can be employed to achieve seamless transitions between camera modules, ensuring excellent consistency in brightness and color presentation across the different camera modules.

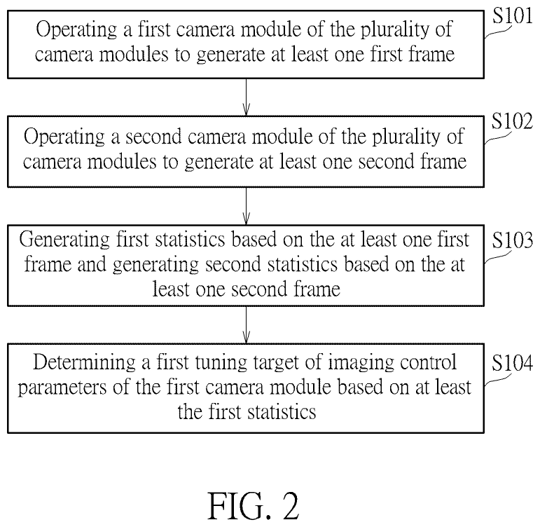

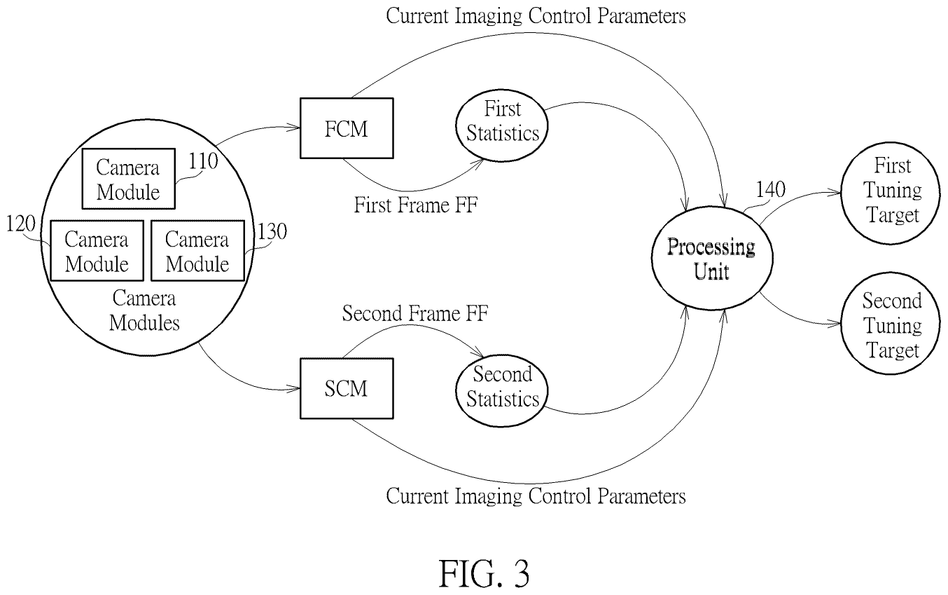

According to one embodiment, the method of controlling an imaging system having a plurality of camera modules comprises following steps as illustrated by FIG. 2. Please refer to FIG. 2 in conjunction with FIG. 3 for comprehensive understandings. At step S201, a first camera module FCM (i.e., one of the camera modules 110, 120 and 130) is operated to generate at least one first frame. At step S102, a second camera module SCM (i.e., another of the camera modules 110, 120 and 130) is operated to generate at least one second frame.

In some embodiments, the first camera module FCM may be one of the background master camera module and the foreground viewing camera module, while the second camera module SCM may be one of the background master camera module and the foreground viewing camera module. In some embodiments, the at least one first frame generated by the first camera module FCM can be used for 3A consistency decision-making, while the at least one second frame generated by the second camera module SCM can be used for 3A consistency decision-making, and/or for live preview, photo/video shooting. In some embodiments, the first camera module FCM is operated in a low frame rate mode, e.g., operated at 20, 10 or 5 FPS, while the second camera module SCM is operated in a normal frame rate mode, e.g., operated at 30 FPS. In some embodiments, the first camera module is operated in a low resolution mode, while the second camera module is operated in a high or native resolution mode. In some embodiments, the first camera module FCM is operated in the non-HDR or SDR capturing mode, while the second camera module SCM is operated in the HDR capturing mode. In some embodiments, a focal length of a lens of the first camera module FCM is either longer or shorter than that of the second camera module SCM.

At step S103, first statistics is generated based on the at least one first frame, and the second statistics is generated based on the at least one second frame. In some embodiments, the first statistics and the second statistics can be calculated based on block-based algorithms or histogram-based algorithms. In some embodiments, the first statistics and the second statistics could include R (Red), G (Green), B (Blue) and/or Y (luminance) information, wherein the Y information can be determined by weighting summation of R, G and B information, and weighting values thereof is configurable based on different requirements.

In some embodiments, the first statistics can be generated by an image signal processing circuit (not shown) of the imaging system 100 or the electronic device 10, the processing unit 140 and/or a first statistical circuit (e.g., a functional block of the control circuitry 113, 123 or 133) of the first camera module FCM based on image data (e.g., brightness and/or color information) of the at least one first frame. In some embodiments, the second statistics can be generated by the image signal processing circuit (not shown) of the imaging system 100 or the electronic device 10, the processing unit 140 and/or a second statistical circuit (e.g., a functional block of the control circuitry 113, 123 or 133) of the second camera module SCM.

At step S104, a first (3A) tuning target of imaging control parameters of the first camera module FCM is generated based on at least the first statistics. Specifically, the imaging control parameters may be 3A control parameters and include at least one of the auto-white-balance control parameters, auto-exposure control parameters and auto-focus control parameters for controlling the camera module. In addition, each of the camera modules 110, 120 and 130 could have their respective imaging control parameters. Furthermore, in some embodiment, the first tuning target of imaging control parameters of the first camera module FCM may be also determined based on the first statistics and current imaging control parameters of the first camera module FCM.

In some embodiment, the first tuning target of imaging control parameters of the first camera module FCM may be determined by the processing unit 140 based on the first statistics and the second statistics. Furthermore, the first tuning target of imaging control parameters of the first camera module FCM may also be determined by based the first statistics, the second statistics and current imaging control parameters of at least one of the first camera module FCM and the second camera module SCM. In some embodiments, the determination of the first tuning target may be based on a function f1, which can be expressed as: T1=f1(S1, S2, C1, C2), wherein T1 is the first tuning target, S1 is the first statistics, S2 is the second statistics, C1 is the current imaging control parameters of the first camera module FCM and C2 is the current imaging control parameters of the second camera module SCM.

Furthermore, after the first tuning target of imaging control parameters of the first camera module FCM is generated, the processing unit 140 would perform inter-module synchronization control between the first camera module FCM and the second camera module SCM. Specifically, the processing unit 140 is configured to implement the inter-module synchronization control by determining a second (3A) tuning target of imaging control parameters of the second camera module SCM. In some embodiments, the second tuning target is determined based on the first tuning target, the first statistics, and the second statistics (or further based on current imaging control parameters of at least one of the first camera module FCM and the second camera module SCM). In some embodiments, the determination of the second tuning target is based on a function f2, which can be expressed as: T2=f2 (T1, S1, S2, C1, C2), wherein T1 is the first tuning target, T2 is the first tuning target, S1 is the first statistics, S2 is the second statistics, C1 is the current imaging control parameters of the first camera module FCM and C2 is the current imaging control parameters of the second camera module SCM.

Due to power control policy, the second camera module SCM may be more sensitive to dynamic scene conditions. This increased sensitivity is primarily based on a higher operating frame rate of the second camera module SCM compared to the first camera module FCM. For example, a frame rate at which the second camera module SCM is operated to generate at least one second frame (e.g., 30 fps or above) is substantially higher than a frame rate at which the first camera module FCM is operated to generate the at least one first frame (e.g., 20 fps or below 30 fps). The difference in frame rates between the two camera modules results in a significant advantage: the at least one second frame generated by the second camera module SCM demonstrates better capability in reflecting or capturing rapid scene conditions changing, particularly in terms of brightness and color variations. Leveraging the better sensitivity, the processing unit 140 is configured with an adaptive mechanism to re-evaluate and adjust the 3A consistency decision-making and control in real-time.

Specifically, in some embodiments, the processing unit 140 is configured to re-determine the second tuning target based on the second statistics in response to scene conditions changing. The re-determination ensures that the imaging system 100 remains optimally configured to the current environmental conditions. Furthermore, to maintain 3A consistency across the camera modules, the processing unit 140 is configured to update the first tuning target based on the re-determined second tuning target, the first statistics and the second statistics after re-determining the second tuning target.

### Decision-Making in HDR Capturing Mode

In the case where the first camera module FCM is operated in the non-HDR or SDR capturing mode and the second camera module SCM is operated in the HDR capturing mode (due to power control policy), the processing unit 140 could determine the 3A tuning target according to second statistics based on the at least one frame generated by the second camera module. That is, the first camera module FCM is operated in the non-HDR or SDR capturing mode to generate the at least one first frame, while the second camera module SCM is operated in the HDR capturing mode to generate the at least one second frame.

In view of this, the first statistics based on the at least one first frame cannot capture the comprehensive range of scene information, particularly in highlight and shadow areas, that is crucial for accurate 3A consistency decision-making and control in HDR scenarios. Consequently, the processing unit 140 needs to reference the second statistics based on the at least one second frame generated in the HDR capturing mode. Such HDR-based statistics provide a more complete representation of the scene, including detailed information in both high and low luminance regions, enabling the processing unit 140 to properly determine the imaging control parameters for optimal HDR capturing (i.e., the second tuning target for the second camera module SCM).

Therefore, in some embodiments, the processing unit 140 is configured to determine the first tuning target based solely on the second statistics, and accordingly perform inter-module synchronization control by determining the second tuning target of the second camera module SCM based on the first tuning target, the first statistics, and the second statistics. Then, the second camera module SCM is operated in the HDR capturing mode based on the second tuning target.

Moreover, in some embodiments, the processing unit 140 may determines the 3A tuning target and control parameters for HDR capturing separately. Specifically, the processing unit 140 is configured to determine control parameters (e.g. HDR operating mode, such as digital conversion gain (DCG) or LMBF) of the HDR capturing mode of the second camera module SCM based on the second statistics. On the other hand, the processing unit 140 is further configured to perform inter-module synchronization control by determining the second tuning target of the second camera module SCM based on the first tuning target, the first statistics, and the second statistics. Then, the second camera module SCM is operated in the HDR capturing mode based on both the second tuning target and the control parameters of the HDR capturing mode.

### FOV Alignment

In the 3A consistency decision-making and control mechanism of the present invention, since the camera modules having different focal lengths are relied upon to generates frames for determining the first statistics and the second statistics, field of view (FOV) alignment between the at least one first frame and the at least one second frame is necessary. Specifically, the processing unit 140 is configured to determine a region of interest (ROI) that encompasses the overlapping areas (e.g. image blocks) of the at least one first frame and the at least one second frame. ROI determination is essential because the live preview is generated based on one of the at least one first frame and the at least one second frame, while the other frame may contain areas not visible in the live preview due to FOV differences.

One of the purposes of establishing ROI is to exclude or minimize the influence of image data from areas that are not visible in the live preview on the calculation of the first statistics and the second statistics. By focusing on the ROI, it is ensured that the 3A consistency decision-making and control are primarily based on the image content that is actually visible to the user in the preview, thereby enhancing the accuracy of 3A consistency decision-making and control.

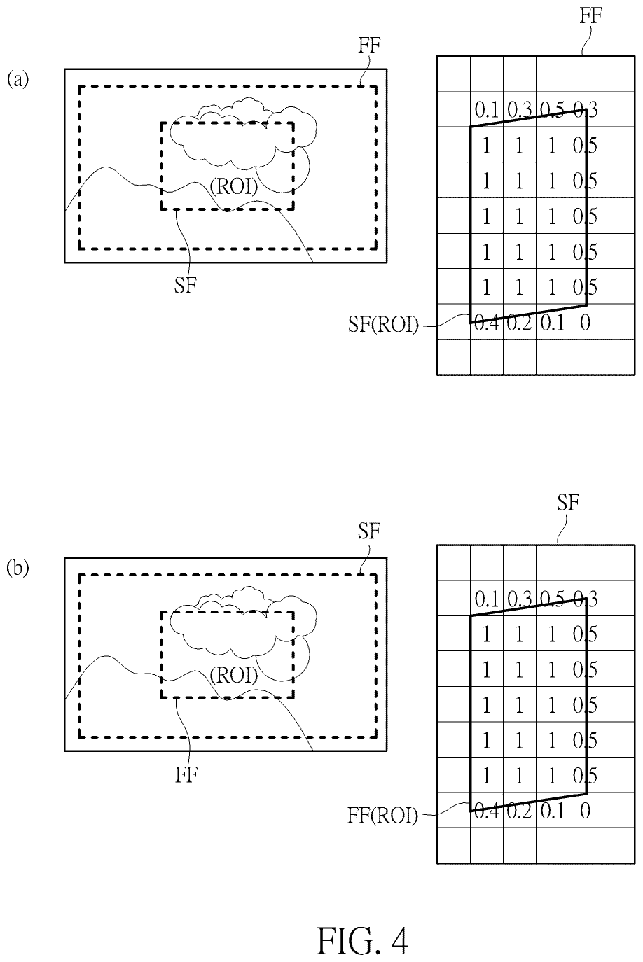

Please refer to FIG. 4 for further understanding. In condition (a) shown by FIG. 4, it is assumed that the first frame FF is generated by the first camera module FCM having a shorter focal length (i.e., a wider FOV) and the second frame SF is generated by the second camera module SCM (also serving the foreground viewing camera module) having a longer focal length (i.e., a narrower FOV). As the second camera module SCM serves as the foreground viewing camera module, determination of the first statistics necessitates the exclusion or reduction of influence introduced by image data (e.g., brightness and/or color information) from partial regions of the first frame FF that lie outside the FOV of the second frame SF. In the FOV alignment process, only the overlapping or partially overlapping regions are utilized to provide meaningful data for 3A consistency decision-making (through weighting assignment). The FOV alignment enables more accurate comparison and analysis on frames generated by different camera modules.

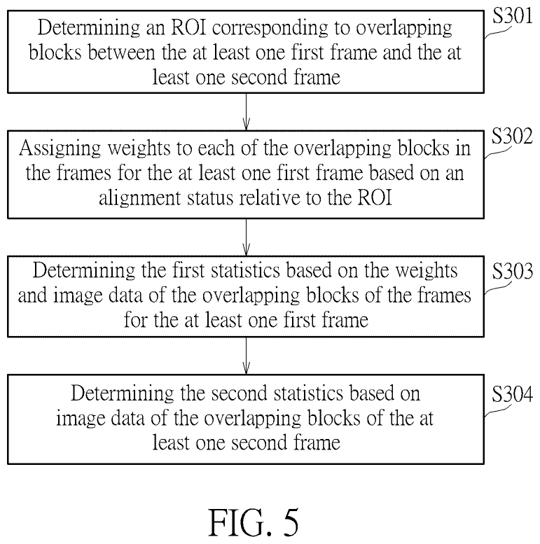

In view of above, a flow chart of a method of determining the first statistics and the second statistics is illustrated in FIG. 5 according to one embodiment. At step S301, the processing unit 140 determines a ROI corresponding to overlapping blocks between the at least one first frame (e.g., the first frame FF) and the at least one second frame (e.g., the second frame SF). At step S302, the processing unit 140 assigns weights to each of the overlapping blocks in the at least one first frame based on an alignment status relative to the ROI. This weighting mechanism is designed to account for the varying degrees of overlap. For example, as illustrated by FIG. 4, those blocks of the first frame FF that are not fully overlapped with the second frame SF (i.e., those blocks partially overlapping with the ROI), are assigned weights less than 1 (i.e., 0<weight<1), wherein the specific weight value may be proportional to the overlap percentage. Those blocks of the first frame FF that are fully overlapped with the second frame SF (i.e., those blocks are fully within the ROI), are assigned weights equal to 1. Those blocks of the first frame FF that are not overlapped with the second frame SF (i.e., those blocks are completely outside the ROI), are assigned weights equal to 0. Through step S302, it is ensured that partially overlapping regions contribute proportionally to the statistics, enhancing the accuracy of 3A consistency decision-making and control.

At step S303, the processing unit 140 determines the first statistics based on the weights (that are determined at step S302) and image data of the overlapping blocks of the at least one first frame. At step S304, the processing unit 140 determines the second statistics based on image data of the overlapping blocks of at least one of the at least one second frame since blocks of the at least one second frame are fully within the ROI, they are typically processed without additional weighting.

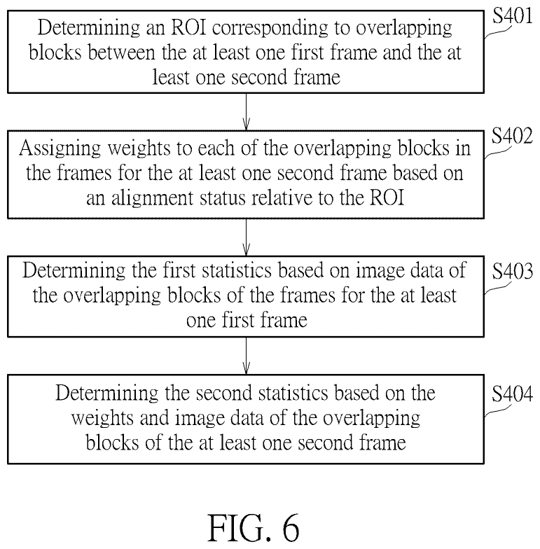

Moreover, in condition (b) shown by FIG. 4, it is assumed that the first frame FF is generated by the first camera module FCM (also serving the foreground viewing camera module) having a longer focal length (i.e., a narrower FOV) and the second frame SF is generated by the second camera module SCM having a shorter focal length (i.e., a wider FOV). As the first camera module FCM serves as the foreground viewing camera module, determination of the second statistics necessitates the exclusion or reduction of influence introduced by image data from partial regions of the second frame SF that lie outside the FOV of the first frame FF. In view of above, a flow chart of a method of determining the first statistics and the second statistics is illustrated in FIG. 6 according to one embodiment. At step S401, the processing unit 140 determines an ROI corresponding to overlapping blocks between the at least one first frame and the at least one second frame. At step S402, the processing unit 140 assigns weights to each of the overlapping blocks in the frames for the at least one second frame based on an alignment status relative to the ROI, wherein blocks fully within the ROI are assigned a weight of 1, blocks partially overlapping with the ROI are assigned weights between 0 and 1, proportional to their overlap percentage and blocks completely outside the ROI are assigned a weight of 0. At step S403, the processing unit 140 determines the first statistics based on image data of the overlapping blocks of the frames for the at least one first frame. At step S404, processing unit 140 determines the second statistics based on the weights and image data of the overlapping blocks of the at least one second frame.

In some embodiments, the FOV alignment can be more than a simple rectangular overlap, as 3D points are projected onto the frames of different camera modules by respective matrices, resulting in potentially arbitrary shapes such as quadrilaterals for the FOV alignment across two frames of different camera modules. In addition, lens distortion is accounted for through matrix transformation, ensuring accurate mapping between two frames of different camera modules. A mapping table can be employed to record the proportion of each image block that falls within the ROI, allowing for precise calculation of statistics even with partial overlaps.

The above-mentioned FOV alignment ensures that the statistics from camera modules with different focal lengths/FOVs are determined based on comparable scene areas, facilitating accurate 3A consistency decision-making and control. The weighted approach for the wider FOV camera module compensates for partial overlaps, while the direct calculation for the narrower FOV camera module maintains the integrity of its full-coverage data.

### Smoothing Control

In the 3A consistency decision-making and control mechanism, the processing unit 140 is further configured to implement a smooth control mechanism for the tuning across different frame rates among different camera modules. Specifically, in some embodiments, the first camera module FCM may serve as the background master camera module and operated at lower frame rate (e.g., 20, 10, or 5 FPS), while the second camera module SCM may serve as the foreground viewing camera module and operated at standard frame rate (e.g., 30 FPS).

The processing unit 140 is configured to determine 3A target adjustment steps based on the frame rate of the first camera module FCM, wherein lower FPS results in larger adjustment steps to ensure responsiveness to changes in the first tuning target of first camera module FCM. Subsequently, the processing unit 140 is configured to interpolate the determined 3A target adjustment steps to obtain intermediate 3A target adjustment steps based on a ratio of the frame rate at which the first camera module FCM is operated to the frame rate at which the second camera module SCM is operated. As such, smoother transitions in the live preview can be ensured by using intermediate steps to facilitate a more gradual adjustment towards the second tuning target. This approach effectively balances the need for responsive adjustments with the requirement for visually smooth transitions in the live preview.

For instance, when the first camera module FCM is operated at 10 FPS and the second camera module SCM is operated at 30 FPS, the processing unit 140 is configured to interpolate the 3A target adjustment steps of the first camera module FCM. Specifically, each 3A target adjustment step for the first camera module FCM is divided into three smaller intermediate 3A target adjustment steps for the second camera module SCM.

Furthermore, in some embodiments, the processing unit 140 is allowed to independently determine a smooth adjustment direction for the intermediate 3A target adjustment steps of the second camera module SCM, distinct from the 3A target adjustment steps of the first camera module FCM. This addresses potential issues such as obstruction of the view of the first camera module FCM or significant brightness disparities between FOVs of the first camera module FCM and the second camera module SCM. By enabling this independent smooth direction determination, the 3A consistency decision-making and control mechanism of the present invention prioritizes user experience by aligning 3A adjustments with the actual scene visible in the live preview, ensuring that the second camera module SCM (e.g., the foreground viewing camera module) can adapt to its immediate environmental conditions.

In conclusion, the 3A consistency decision-making and control mechanism of the present invention represents a significant advancement in mobile imaging technology. The present invention offers two advantages that address critical challenges in modern mobile imaging systems. Firstly, it demonstrates efficient multi-camera operation, maintaining low power consumption for one camera module while multiple modules are simultaneously activated. This capability ensures energy efficiency without compromising the accuracy of 3A consistency across all camera modules, thereby optimizing both performance and power management in complex multi-camera module configuration. Secondly, the 3A consistency decision-making and control mechanism guarantees visually seamless transitions in the live preview when switching between camera modules. This smooth transition maintains consistency in the live preview by eliminating noticeable shifts in exposure, color balance, or focus during camera module switches, significantly enhancing user experience during photography and videography sessions.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling an imaging system having a plurality of camera modules, comprising:
operating a first camera module of the plurality of camera modules to generate at least one first frame;
operating a second camera module of the plurality of camera modules to generate at least one second frame;
generating first statistics based on the at least one first frame and generating second statistics based on the at least one second frame; and
determining a first tuning target of imaging control parameters of the first camera module based on at least the first statistics.

2. The method of claim 1, further comprising:
performing inter-module synchronization control on at least one of the camera modules by determining a second tuning target of imaging control parameters of the second camera module based on the first tuning target, the first statistics, and the second statistics.

3. The method of claim 1, further comprising:
determining the first tuning target of the imaging control parameters of the first camera module based on the first statistics and the second statistics.

4. The method of claim 1, wherein the imaging control parameters include at least one of auto-white-balance control parameters, auto-exposure control parameters and auto-focus control parameters.

5. The method of claim 2, further comprising:
in response to scene conditions changing, re-determining the second tuning target based on the second statistics.

6. The method of claim 5, further comprising:
updating the first tuning target based on the re-determined second tuning target, the first statistics and the second statistics.

7. The method of claim 1, wherein the step of generating the at least one first frame and the at least one second frame comprises:
generating the at least one first frame by operating the first camera module at a first frame rate; and
generating the at least one second frame by operating the second camera module at a second frame rate;
wherein the second frame rate is greater than the first frame rate.

8. The method of claim 1, wherein the step of generating the first statistics and generating the second statistics comprises:
utilizing an image signal processing circuit of the imaging system to calculate the first statistics and the second statistics; or
utilizing a first statistical circuit of the first camera module to calculate the first statistics and utilizing a second statistical circuit of the second camera module to calculate the second statistics.

9. The method of claim 1, wherein a focal length of a lens of the first camera module is either longer or shorter than that of the second camera module.

10. The method of claim 1, further comprising:
determining a region of interest (ROI) corresponding to overlapping blocks between the at least one first frame and the at least one second frame;
assigning weights to each of the overlapping blocks in the at least one first frame based on an alignment status relative to the ROI;
determining the first statistics based on the weights and image data of the overlapping blocks of the at least one first frame; and
determining the second statistics based on image data of the overlapping blocks of at least one of the at least one second frame.

11. The method of claim 1, further comprising:
determining an ROI corresponding to overlapping blocks between the at least one first frame and the at least one second frame;
assigning weights to each of the overlapping blocks in the frames for the at least one second frame based on an alignment status relative to the ROI;
determining the first statistics based on image data of the overlapping blocks of the frames for the at least one first frame; and
determining the second statistics based on the weights and image data of the overlapping blocks of the at least one second frame.

12. The method of claim 1, wherein the step of generating the at least one first frame and the step of generating the at least one second frame comprises:
generating the at least one first frame by operating the first camera module in a non-high dynamic range capturing mode; and
generating the at least one second frame by operating the second camera module in a high dynamic range capturing mode.

13. The method of claim 12, further comprising:
determining the first tuning target based solely on the second statistics, wherein the second statistics are derived from the at least one second frame generated by the second camera module operating in the high dynamic range capturing mode;
performing inter-module synchronization control by determining a second tuning target of imaging control parameters of the second camera module based on the first tuning target, the first statistics, and the second statistics; and
operating the second camera module in the high dynamic range capturing mode based on the second tuning target.

14. The method of claim 12, further comprising:
determining control parameters of the high dynamic range capturing mode of the second camera module based on the second statistics;
performing inter-module synchronization control by determining a second tuning target of imaging control parameters of the second camera module based on the first tuning target, the first statistics, and the second statistics; and
operating the second camera module in the high dynamic range capturing mode based on both the second tuning target and the control parameters of the high dynamic range capturing mode.

15. The method of claim 1, further comprising:
preforming a gradual adjustment process on the second camera module using intermediate steps to ensure a smoother transition towards the second tuning target.

16. A computer readable medium comprising a plurality of instructions that in response to being executed on a computing device, cause the computing device to operate by:
operating a first camera module of the plurality of camera modules to generate at least one first frame;
operating a second camera module of the plurality of camera modules to generate at least one second frame;
generating first statistics based on the at least one first frame and generating second statistics based on the at least one second frame; and
determining a first tuning target of imaging control parameters of the first camera module based on at least the first statistics.

17. An apparatus for controlling an imaging system, comprising:
at least one memory configured to store a plurality of instructions; and
at least one processor communicatively coupled to the least one memory, configured to execute the plurality of instructions to perform operations of:
generating first statistics based on at least one first frame that is derived by operating a first camera module of a plurality of camera modules of the imaging system;
generating second statistics based on at least one second frame that is derived by operating a second camera module of the plurality of camera modules; and
determining a first tuning target of imaging control parameters of the first camera module based on at least the first statistics.
